(19) United States
(12) Patent Application Publication
(10) Pub. No.: US 2010/0328306 A1
(43) Pub. Date: Dec. 30, 2010

(54) LARGE FORMAT HIGH RESOLUTION INTERACTIVE DISPLAY

(75) Inventors: Dennis W. Chau, Chicago, IL (US); Andrew Edward Johnson, Forest Park, IL (US); Edward M. Kahler, Evanston, IL (US); Robert Kooima, Baton Rouge, LA (US); Jason Leigh, Chicago, IL (US); Mhd Khairi Reda, Park Ridge, IL (US); Luc (Pierre Marie) Renambot, Chicago, IL (US)

Correspondence Address: GREER, BURNS & CRAIN, 300 S WACKER DR, 25TH FLOOR, CHICAGO, IL, 60606, US

(73) Assignee: The Board of Trustees of the Univer of Illinois, Urbana, IL (US)

(21) Appl. No.: 12/918,171

(22) PCT Filed: Feb. 19, 2009
(86) PCT No.: PCT/US09/34524

§ 371 Date: Aug. 18, 2010

Related U.S. Application Data
(60) Provisional application No. 61/066,188, filed on Feb. 19, 2008.

(51) Int. Cl. G06T 15/00; G06F 3/041

(52) U.S. Cl. 345/419; 345/173

(57) ABSTRACT

An interactive display device of a preferred embodiment includes a display surface and a touch interface associated with the display surface. A first LCD layer generates a dynamic parallax barrier and a second LCD layer generates stereoscopic images in cooperation with the first LCD layer. A light source backlights the first and second LCD layers. A preferred method for controlling an interactive stereoscopic display device provides two-dimensional content to be displayed by the second LCD layer, three-dimensional content to be displayed by the second LCD layer, and generates a description that overlays two-dimensional content to be rendered monoscopically onto three-dimensional content to be rendered stereoscopically. Parallax barrier content is displayed on the first LCD layer. A preferred method for displaying images overlays monoscopic and stereoscopic image data into combined image data and displays the combined image data to the second LCD layer. Dynamic parallax barriers are displayed on the first LCD layer in cooperation with the second LCD layer. User interaction with the display device is sensed, and the combined image data is altered in response to user interaction.

### PRIORITY CLAIM AND REFERENCE TO RELATED APPLICATION

The application claims priority under 35 U.S.C. §119 from prior provisional application Ser. No. 61/066,188, which was filed Feb. 19, 2008.

### STATEMENT OF GOVERNMENT INTEREST

This invention was made with government support under Contract No. CNS 0420477 awarded by National Science Foundation. The government has certain rights in the invention.

### TECHNICAL FIELD

Fields of the invention include interactive data display, exploration and collaboration.

### BACKGROUND ART

Standard computer displays greatly limit the ability of a user to explore, interact and collaborate with others. Relatively small amounts of data are presented on a standard computer display. Use of multiple displays is common, but multiple displays do little to solve the difficulties encountered when attempting to view and explore complex data.

Scientists, designers and engineers increasingly focus on complex phenomena, rely on instruments that produce greater volumes of data, and collaborate with geographically distributed teams. General purpose computing, gaming and other applications also can present complex and highly detailed environments and interactions. A central challenge for researchers using scientific systems and other users of gaming and general purpose systems is the ability to manage the increased scale and complexity of the information and environment presented by a display. Greater scale and complexity places a heavy strain on computational systems and infrastructure. Additionally, the usability of such systems is also limited by human factors, such as their cognition and/or attention-span.

Large interactive displays have been developed, primarily for the field of scientific research and collaboration. One example is the LambdaVision 100-Megapixel wall-sized LCD tiled display introduced by Electronic Visualization Laboratory (“EVL”), which quickly resulted in over a dozen research laboratories constructing compatible instruments, called OptIPortals. EVL also developed the Scalable Adaptive Graphics Environment (“SAGE”) operating system software to enable domain scientists to work and collaborate using these displays The massive resolution afforded by these displays enabled users to view large collections of high-resolution visualizations generated in real-time from compute clusters housed at supercomputing facilities around the world.

These displays however, include limitations, which can reduce usability when being used with certain applications. One such limitation is the position and/or orientation of the display. Since electronic data often replaces the physical presentation of data, there is a concern that users will have difficulty adapting to the electronic presentation of data. Therefore, one design criteria of such displays is to provide users with the feeling of working in a traditional work environment, thereby increasing usability.

Another display device developed by EVL is the LambdaTable 24-Megapixel table-oriented LCD display. This device employs a horizontal display and presents a more natural working environment that encourages visualizations and collaborations as it replicates common human practices of working with whiteboards, printouts, blue prints, etc. where multiple people gather around a table to view data and/or documents.

Users of the LambdaTable interact with “pucks”, which are used to control the display. Special purpose pucks, for example, permit moving, shrinking, selecting, and magnifying a portion of data being displayed. Users can select and manipulate data with the pucks, and the table-sized display allows multiple users to view and interact with the data simultaneously. Displays using pucks however, have several limitations. An example limitation is that the number of users interacting with a display is limited by the number of available pucks. Pucks are also costly and subject to loss or damage, thereby requiring replacement.

One display device that avoids use of such pucks is the projector-based Microsoft® Surface display. The Surface employs a multi-touch interface, which allows a user to interact with the display by touching it with one or more fingers, thereby forgoing the need for pucks.

To further enhance usability and more closely resemble a user's natural working environment, some developers have introduced displays capable of producing three-dimensional (“3D” or “stereoscopic”) images, instead of the traditional two-dimensional (“2D” or monoscopic) images as provided in the examples above. Examples of stereoscopic displays include the Philips® MultiSync non-interactive LCD display product line. However, since these displays are configured specifically to display stereoscopic images, they are greatly limited in their ability to display monoscopic images. While such monoscopic images can be displayed, the quality/resolution is considerably poor when compared to traditional monoscopic displays.

### DISCLOSURE OF INVENTION

An interactive display device of a preferred embodiment includes a display surface and a touch interface associated with the display surface. A first LCD layer generates a dynamic parallax barrier and a second LCD layer generates stereoscopic images in cooperation with the first LCD layer. A light source backlights the first and second LCD layers.

A preferred method for controlling an interactive stereoscopic display device provides two-dimensional content to be displayed by the second LCD layer, three-dimensional content to be displayed by the second LCD layer, and generates a description that overlays two-dimensional content to be rendered monoscopically onto three-dimensional content to be rendered stereoscopically. Parallax barrier content is displayed on the first LCD layer.

A preferred method for displaying images overlays monoscopic and stereoscopic image data into combined image data and displays the combined image data to the second LCD layer. Dynamic parallax barriers are displayed on the first LCD layer in cooperation with the second LCD layer. User interaction with the display device is sensed.

### BRIEF DESCRIPTION OF THE DRAWINGS

FIG. 1A is a schematic side view of a preferred embodiment of an interactive display device of the invention;

FIG. 1B is a schematic side view of the device of FIG. 1A;

FIG. 2 is an exploded perspective view of a dynamic parallax barrier;

FIG. 3 illustrates a preferred software and control system for controlling an interactive display device of the invention;

FIG. 4 is a schematic perspective view of a parallax barrier;

FIG. 5 is a schematic perspective view of an alternate embodiment of a parallax barrier;

FIG. 6 is a schematic perspective view of an LCD screen and an alternate embodiment of a parallax barrier;

FIG. 7 is a schematic perspective view of a preferred embodiment of an interactive display device of the invention; and

FIG. 8 is a schematic perspective view of another a preferred embodiment of an interactive display device of the invention.

### PREFERRED MODES FOR CARRYING OUT THE INVENTION

Preferred embodiments of the invention provide an interactive display device, which is capable of displaying both monoscopic and stereoscopic images. However, unlike other stereoscopic displays known in the art (e.g., the Philips® Multi-sync), the device displays monoscopic images as resolutions comparable to traditional monoscopic displays (i.e., full native resolution). In other words, monoscopic image resolution is not compromised by the device's ability to display stereoscopic images. The display device is also capable of displaying both monoscopic images and stereoscopic images simultaneously. That is, users can view both monoscopic windows and stereoscopic windows side by side without having to wear specialized 3D glasses or having to switch between modes. This minimizes physical encumbrances associated with the current commercial instruments. The device also provides the user with either touch or gesture-based interaction.

The usability of a display system is limited by human factors, such as cognition and/or attention-span. Usability is enhanced when a user is provided with the feeling of working in a traditional work environment. However, depending on the application being run, users will have different expectations regarding the working environment. The ability to display both monoscopic and stereoscopic images allows for greater flexibility in representing a traditional work environment for a given application.

For example, consider a group of individuals using the device to collaborate and research geographical information. A traditional working environment may include information likes maps, pictures, statistical data, etc. While some of this information lends itself to being displayed as a stereoscopic image (e.g., maps), other information is traditionally presented as a monoscopic image (e.g., statistical data). Consider for example, a spreadsheet of data concerning a particular region on a map. In a traditional working environment, geologists would likely use a map or a globe to view this particular region along with a standard spreadsheet of data. Using devices of the invention, users can view a stereoscopic representation of the map and simultaneously view a monoscopic representation of the statistical data alongside the map. Similarly, general purpose computing, gaming, communication and many other systems can benefit from the simultaneous clear display of monoscopic data along with stereoscopic data presented by a display of the invention.

An interactive display device of a preferred embodiment includes a display surface and a touch interface associated with the display surface. A first LCD layer generates a dynamic parallax barrier and a second LCD layer generates stereoscopic images in cooperation with the first LCD layer. A light source backlights the first and second LCD layers.

A preferred method for controlling an interactive stereoscopic display device provides two-dimensional content to be displayed by the second LCD layer, three-dimensional content to be displayed by the second LCD layer, and generates a description that overlays two-dimensional content to be rendered monoscopically onto three-dimensional content to be rendered stereoscopically. Parallax barrier content is displayed on the first LCD layer.

A preferred method for displaying images overlays monoscopic and stereoscopic image data into combined image data and displays the combined image data to the second LCD layer. Dynamic parallax barriers are displayed on the first LCD layer in cooperation with the second LCD layer. User interaction with the display device is sensed

Preferred embodiments of the invention will now be discussed with respect to the drawings. The drawings may include schematic representations, which will be understood by artisans in view of the general knowledge in the art and the description that follows. Features may be exaggerated in the drawings for emphasis, and features may not be to scale.

A preferred embodiment of the invention is a large format high resolution interactive display device 10 configured as desk, which is likely to replace a desk and computer workstation. It is noted that such devices can also be configured in other forms (e.g., a table or portable case) as desired by the user. The preferred embodiment display 10 is sized similarly to a traditional desk, providing a generous display and workspace. The desk is a single example, and the invention is not limited thereto. The display 10 can be configured in other arrangements, for example on stands or mounts to present a vertical display and workspace or a horizontal display and workspace when the device 10 is configured as a desk.

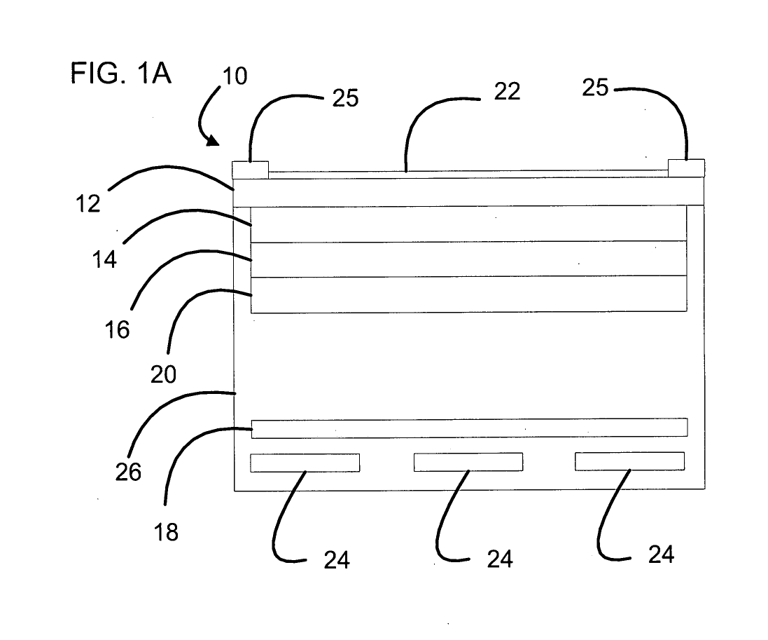

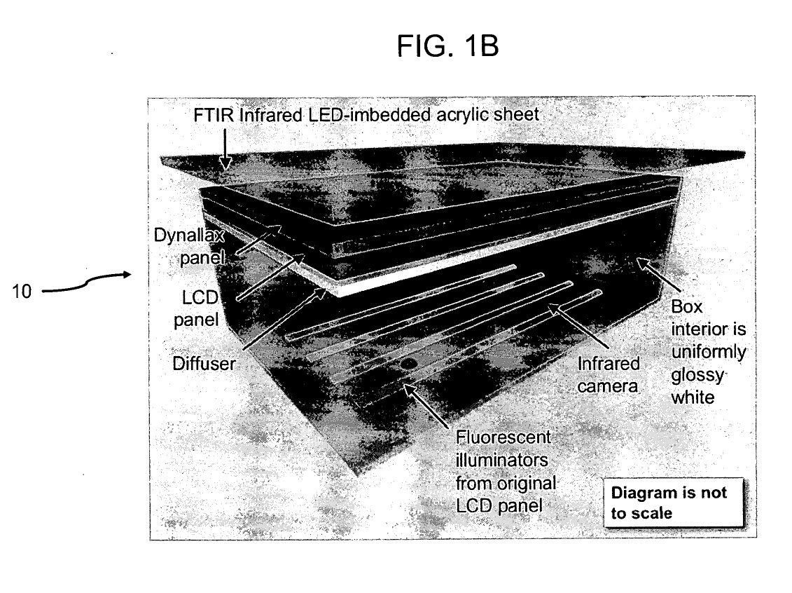

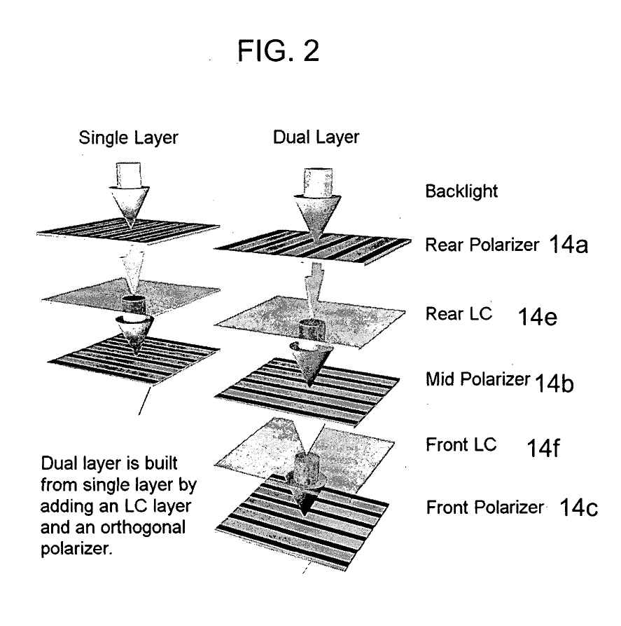

Referring now to FIGS. 1A and 1B, the preferred embodiment of the display device 10 is shown. Included in the device 10 is a top layer of a clear sheet 12, preferably made of an acrylic material, such as polymethyl methacrylate or another clear polymer. The clear sheet 12 presents a display surface to user. Further included in the device 10 is a first LCD layer 14 for presenting a dynamic parallax barrier to enable autostereopsis. Dynamic parallax barriers can be built from one or more LCD Panels as shown in FIG. 2, which labels the sub parts of the barrier 14 of FIG. 1. While it is contemplated that devices will be fabricated from new techniques, example devices have been built from components of existing LCD panels. To build a dynamic parallax barrier from existing LCD displays (left side of FIG. 2), two LCD monitors are dissembled and re-assembles them into a common enclosure, sharing a common backlight. This creates a rear polarizer 14a, a mid polarizer 14b, and a front polarizer 14c. Liquid crystal panels 14e and 14f are disposed between the polarizer panels 14a-14c. Angles of polarization between the two LCD screens are orthogonal to each other. This requires careful removal of the rear polarizer from the front LCD. Because the illumination reaching the front LCD is rotated 90° by the rear LCD, the front LCD behaves in the inverse, and the parallax barrier is drawn white-on-black rather than black-on-white. Preferred dynamic parallax barriers have been developed by researchers at the University of Illinois at Chicago, and are has and are described in a web-available publication by Peterka et al., entitled “Dynallax: Solid State Dynamic Parallax Barrier Autostereoscopic VR Display.” An autostereoscopic display with the dynamic parallax barrier is also described in U.S. Patent Publication 20080143895.

Referring back to FIGS. 1A and 1B, a second LCD layer 16 generates both monoscopic and/or stereoscopic images (the term screen will be used to describe a user's view of both the first LCD layer 14 and the second LCD layer 16). A light source 18, such as fluorescent tubing light emitting diodes or other backlighting, illuminates the LCD layers 14 and 16. A thin diffuser 20 is preferably disposed between the second LCD layer 16 and the light source 18 averages the illumination from the light source 18. One or more additional diffusers can be used to further average the illumination from the light source and eliminate illumination hot spots.

Users interact with the device 10 via a touch interface, which preferably provides multi-touch interaction with the device. The preferred touch interface renders external devices, e.g., pucks, unnecessary, though they may be applied if desired. The touch interface permits users to use their own hands to interact with the device 10. An example touch interface utilizes infrared LEDs 22 that are embedded in or around the clear sheet 12 to sense human contact. Preferably, there is also a gesture interface. An infrared camera 24 below the diffuser 20 cooperates with the infrared LEDs 22 to provide the touch interface. The diffuser 20 can have an opening or clear section to provide the camera 24 with a view through the diffuser to the clear sheet 12 for determining user interaction. The camera 24 and light source 18 are preferably disposed in a box 26 having a generally uniform glossy white interior.

The touch sensing used in the preferred embodiment device 10 is based upon use of Frustrated Total Internal Reflection (“FTIR”). See, Han, “Low-cost multi-touch sensing through frustrated total internal reflection.” 2005 Proceedings of the 18th annual ACM symposium on User interface software and technology. Seattle, Wash., USA, ACM. By this technique, the infrared LEDs 22 are embedded at the edges of the clear sheet 12. When an object is brought within several wavelengths' distance, the internally reflected infrared light is able to pass through the acrylic sheet where it is detected by an infrared camera. Han's original implementation was applied to projection-based screens, but has been adapted in the invention to work with LCD panels. Even when an LCD panel is completely opaque to visible light, the infrared light is able to pass through and user interaction can be detected with the camera 24 that senses the internally reflected light caused by user interaction with the screen. An advantage of using LCD panels is that they can be viewed in a normally lit room.

Tiled-display surfaces, present a unique issue with respect to constructing FTIR touch screens in that the mullions (i.e., borders) can occlude the infrared camera's view of portions of the FTIR screen. This can overcome this by first building the FTIR screen as a single large acrylic sheet rather than as a tiling of screens, and raising it some distance (between 0.5″ and 1″) above the dynamic parallax barrier panel depending on the field of view of the camera.

The device 10 also preferably includes a gesture interface. A gesture interface uses sensors or cameras to detect gestures made by a user without requiring the user to touch the clear sheet 12. The gesture interface can detect a hand or other an object in close proximity to the sheet 12, and permit gesture interaction with the device 10. Preferably, infrared cameras 25 equipped with infrared illuminators are used for gesture tracking (FIG. 1A). The cameras 25 are mounted around the perimeter of the top sheet 12 and pointed inward so that the field of view creates a tracking volume. The cameras have a relatively short depth of field therefore only rendering relatively close objects as being sufficiently distinct to register as a trackable object.

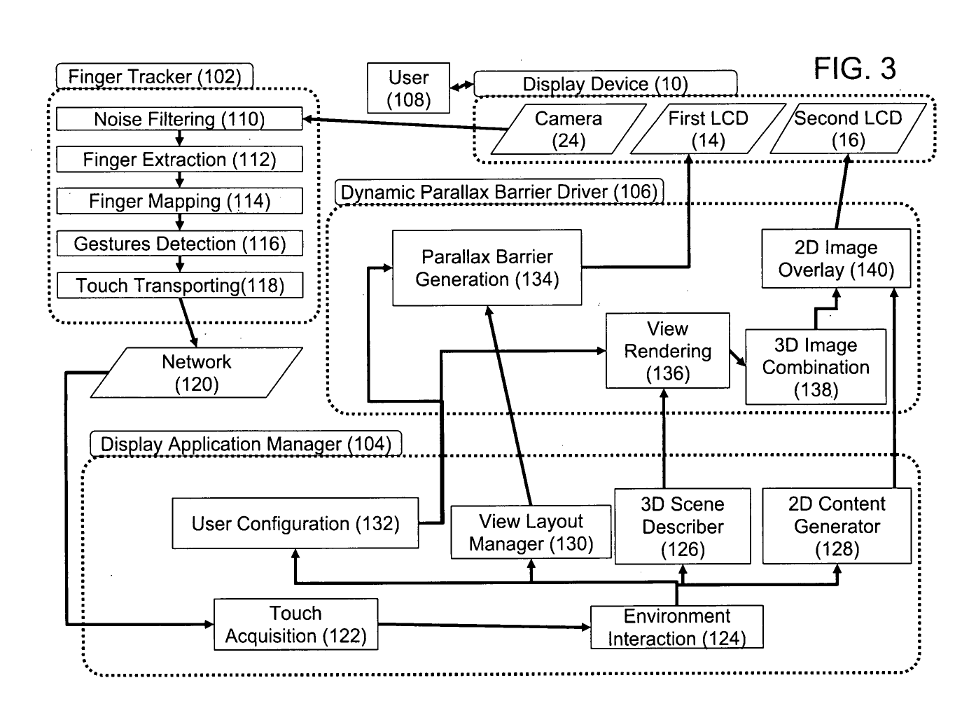

The device's ability to display images and interact with one or more users is preferably managed by a software system. A preferred software architecture and method 100 for the device is shown in FIG. 3. The method 100 is preferably stored on a computer-readable storage medium included in the display device 10. The system 100 provides a finger tracker module 102 for gathering and transporting user touch data, a display application manager module 104, which uses the touch data to update the environment, and finally a dynamic parallax barrier driver module 106 for providing image data to the device's LCD layers 14, 16.

In the finger tracker module 102, a noise filter component 110 causes the infrared cameras 24 to take raw images of the user's fingers or other objects as he interacts with the device, which are smoothed with various filters to reduce noise levels. Next, a finger extractor 110 examiners the contours and position of “blobs” found in the images. This will identify the finger locations of the user 108 on the clear sheet 12 of the device (FIGS. 1A and 1B). A finger mapper 114 then maps finger positions from the camera 24 to a unified screen coordinate system and eliminates duplicate fingers that are picked up by any adjacent cameras if multiple camera are used. Next, a gesture detection component 116 analyzes the movement of fingers and their relative distances to identify certain predetermined touches or gestures. For example, the user 108 may move two fingers simultaneously to pan the image displayed on the device 10. Finally, a touch transporter 118 sends touch interface data such as finger touches, movements, and positions, and gesture interface data, such as gesture positions and speeds to the application module 104. Such communication is conducted over a network 120 such that the finger tracker module 102 can exist on a separate computer from the remaining modules, if desired.

Next, a touch acquisition component 122 in the display application manager 104 acquires the touch and gesture interface data provided by the finger tracker module 102 such that an environmental interaction component 124 can manipulate and update the virtual environment and/or any object it contains. Thereafter, a three-dimensional screen descriptor 126 generates a high level description of the three-dimensional scene based on the current state of the environment. This description includes the contained three-dimensional objects, their positions, and their surface material properties. Similarly, a two-dimensional content generator 128 generates all two-dimensional content including for example, overlay images. Next, a view layout manager 130 generates a description of the screen and specifies the portions of the screen that have two-dimensional content, which should be rendered monoscopically, and the portions of the screen that have three-dimensional content, which should be rendered stereoscopically. As will be descried in further detail below, the dynamic parallax barrier driver module 106 affords for this configuration to be dynamic, and thus, the number, position, and size of two-dimensional content can be changed by the display application manager module 104 in real-time. A user configuration component 132 then generates a description of the number of autostereoscopic views to be generated and their corresponding vantage point in three-dimensional space. This vantage point can able be modified in real-time to support a variable number of users.

The last module is the dynamic parallax barrier driver module 106, which has a parallax barrier generation component 134 for generating a barrier by either drawing alternating opaque and transparent lines over three-dimensional content, or leaving areas over two-dimensional content transparent. Parameters of the parallax barrier are altered depending on the user configuration component 132 in the display application manager module 104. The resulting barrier image is then displayed on the first LCD layer 14 on the device 10. A view rendering component 136 provides for each user, a pair of images (one for the left eye and one for the right eye) that are rendered based on the scene information generated by the three-dimensional scene descriptor component 126. The total resulting number of images equals the number of users multiplied by two. Next, a three-dimensional image combination component 138 electronically slices the rendered images into a plurality of thin pieces, which are combined to form a single image. Finally, a two-dimensional image overlay component 140 overlays the two-dimensional images onto the single image to create an image which is displayed on the second LCD panel 16 of the device 10.

The dynamic parallax barrier autostereoscopic technique used in devices of the invention enables an LCD display to support viewing in several simultaneous modes, with the viewing mode selectable on a per-pixel basis. A single-viewer tracked autostereo mode enables a high-resolution virtual-reality experience with first-person perspective, giving ideal viewing of stereoscopic polygonal and volumetric data. Dual-viewer tracked autostereo mode enables a shared virtual-reality experience, with a first-person perspective for each user. Panoramic autostereo mode provides a shared stereoscopic perspective to multiple users, enabling group collaboration with stereoscopic data. Monoscopic display at the LCD's full native resolution allows for the normal viewing of fine text and high-resolution monoscopic digital imagery on both instruments.

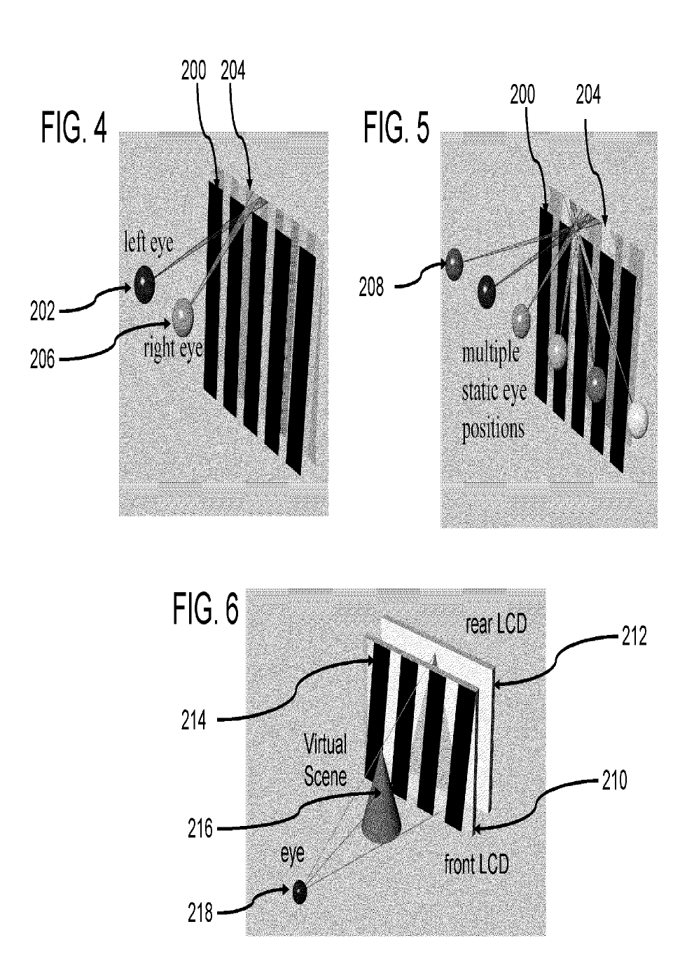

The dynamic parallax barrier technology enables these modes and utilizes a parallax barrier, which is an alternating sequence of opaque and transparent regions. An example is shown in FIG. 4. Typically, this parallax barrier is mounted in front of an LCD display, offset from it by a relatively small distance. The displayed image is correspondingly divided into similar regions 200 of perspective views, such that all of the regions belonging to one perspective are visible only by one eye 202, and likewise a different set of regions 204 corresponding to another perspective is visible by the other eye 206. The eyes 202, 206 are thus simultaneously presented with two disparate views, which the brain fuses into one stereoscopic image. Parallax barriers are usually mounted in a rotated orientation relative to the pixel grid to minimize or restructure the moiré effect that results as an interference pattern between the barrier and pixel grid.

Parallax barrier autostereo displays follow one of two design paradigms. Tracked systems produce a stereo pair of views that follow the user in space, given the location of the user's eyes or head from the tracking system, these are strictly single-user systems

Another option is the untracked panoramagram where a sequence of perspective views is displayed from slightly varying vantage points. An example is shown in FIG. 5, which also has regions 200, 204 as described above. However, in this approach, the regions 204 are configured such that the display can be viewed by multiple users (i.e., by multiple static eye positions 208). This option is well-suited to preferred embodiment large format high resolution interactive display tables. Multiple users can view this type of display, even upside-down, with limited “look-around” capability. This enables viewers to stand on the two long sides of large format high resolution interactive display table and still see correct stereoscopic views. The degree of look-around and the usable range of the display are determined by the number of views in the sequence. There is a trade-off between the number of views and the effective resolution of the three-dimensional image, and tests have demonstrated that a 9-view sequence is optimal given the native resolution of an example 30″ display and its intended pattern of use.

An example is shown in FIG. 6, in contrast to existing autostereo displays, the dynamic parallax barrier is constructed from a fully addressable LCD screen 210 placed in front of the screen 212 used to render the stereo scene 214 and to create a virtual scene 216 from the viewpoint of an eye 218. This approach permits greater flexibility and usability while mitigating some of the drawbacks of the previous methods. The front screen 210 can be rendered transparent, converting the display to a full-resolution monoscopic system, and eliminating the degradation of resolution commonly associated with static-barrier displays. In stereo mode, the parameters of the parallax barrier can be updated in real time, so that optimal viewing conditions are maintained at all times, regardless of view distance. Sensitivity to system latency is reduced by accommodating rapid head movements with a translation of the front barrier pattern. Moreover, the viewing mode may be adapted in real time by modifying the barrier parameters in software. Dynamic parallax barriers can spatially multiplex more than one pair of stereo channels at the same time, so multiple tracked viewers can either view their own individual perspective of the same scene, or entirely different scenes. Any of these variations are possible on a per-tile basis or on a subset of a tile, since they are all performed at pixel scale in software. All of these features occur by virtue of the barrier being dynamic and fully addressable like any other graphical display.

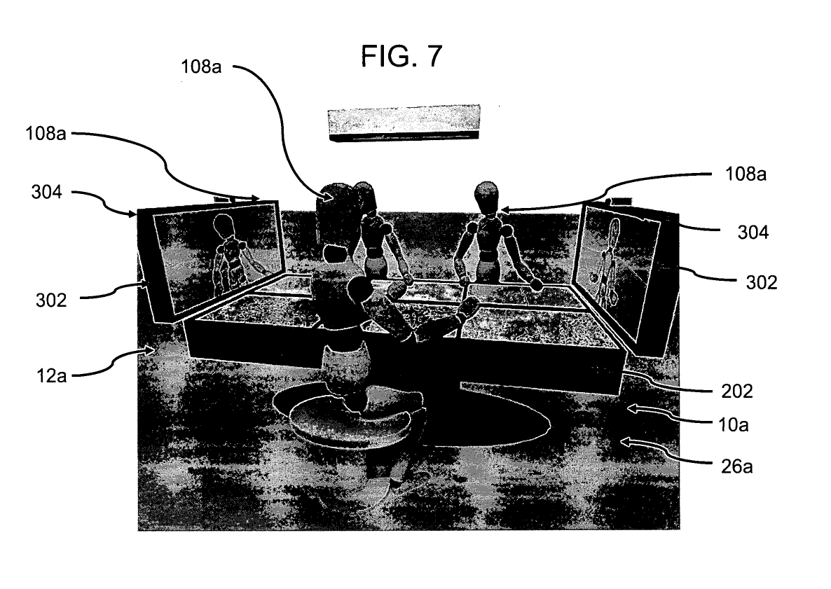

For very large displays of the invention, particularly in the table embodiments, until large enough high resolution displays are available, some embodiments that exceed the size of currently available LCD panels may require tiling of multiple LCD panels in each of the first and second layers. An example embodiment of a tiled device is shown in FIG. 7. In this embodiment, the device 10a is divided into six groups of LCD panels 300 for use with multiple users 108a. Additional software may be required to permit such tiling. An example operating SAGE, which is an operating system for tiled-display environments, that lets users launch distributed visualization applications on remote clusters of computers and stream the visualizations directly to their tiled displays, where they can be viewed and manipulated.

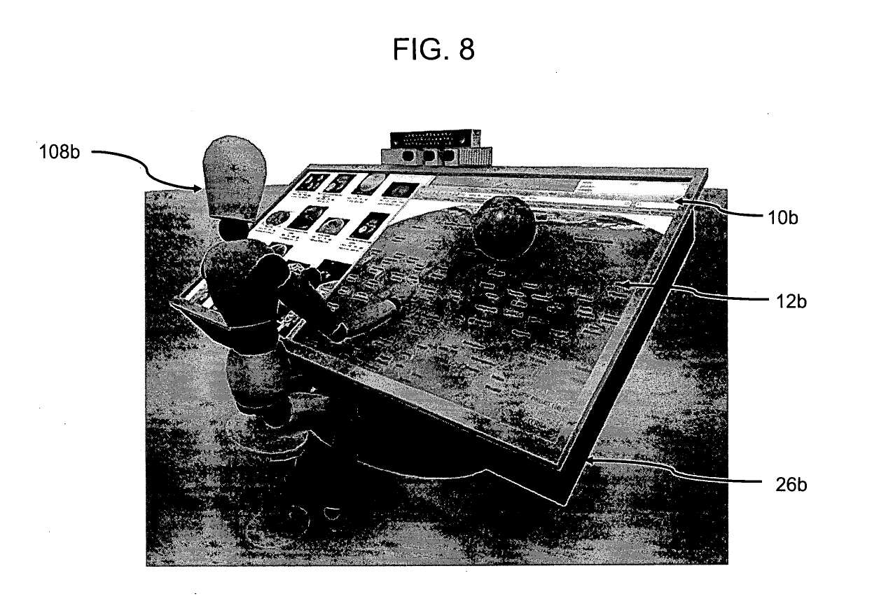

While tiling LCDs introduces mullions, the increased resolution provided is more important. The effect of the mullions can be minimized by rendering graphics is rendered in such a way as to take them into account (e.g., by placing virtual pixels behind them so the effect is like looking out of a window). The need for mullions will disappear when LCD display technology (or another type of comparable display) can make completely seamless and scalable flat-panel displays of desirable size and necessary resolution. For comparison, an example of a non-tiled device 10b is shown in FIG. 8, which is slightly angled towards and is being operated by a single user 108b.

A preferred embodiment device provides 24-Megapixel resolution, and generates 9 fixed views. The preferred embodiment device also provides 8-Megapixel resolution, and generates user-centered-perspective autostereoscopic views. However, as larger LCD displays become available with high resolution, the need, for example, for multiple LCD panels in layers of a preferred embodiment table of the invention may be alleviated.

Preferred embodiment displays provide resolution that approaches print quality (approximately 72-dpi, or higher). With current LCD technology at a reasonable cost, and example embodiment large format high resolution interactive display table can be built using twelve 30″ (4-Megapixel) LCD panels (6 for image generation, and 6 for stereo separation) providing a total resolution of 24-Megapixels.

As noted, devices of the invention will have many important applications for a variety of users. Some of these users are domain scientists who increasingly rely on digital infrastructure (also known as cyberinfrastructure) and global collaboration to conduct research. Therefore, the device is preferably equipped with 1 to 10 Gigabit/s network interfaces and switches that can enable them to connect to 10-Gigabit national and international high-speed networks, such as National Lambda Rail, Internet2, and the Global Lambda Integrated Facility. As public and private networks evolve to match speeds of these high speed networks, displays of the invention can be configured to communicate with as yet to be developed networks and protocols having suitable data communication speeds.

Preferred display devices of the invention also support life-sized distance collaboration via high-definition videoconferencing with remote participants who want to be part of a meeting, and to leverage high speed networks of National Science Foundation's cyberinfrastructure facilities, such as the TeraGrid and future Petascale Facility, over high-speed networks. Further, the devices provide spatialized audio feedback with the visuals that are presented (e.g., the audio from a videoconference is proximally located with the videoconferencing image.) As shown in FIG. 7, preferably, high-definition displays 302 are positioned at the ends of the table and are equipped with high-definition video cameras 304 and network controllers configured for networking the device 10a to at least one additional remote display device for remote collaboration. When not engaged in a videoconference, side screens can be used as additional surfaces on which information can be posted. Above the users are sound projectors that enable audio to be spatialized along the length of the table.

While specific embodiments of the invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. An interactive display device comprising:
a display surface;
a touch interface associated with said display surface;
a first LCD layer for generating a dynamic parallax barrier;
a second LCD layer for generating stereoscopic images in cooperation with said first LCD layer; and
a light source disposed to backlight said first and second LCD layers.

2. The device of claim 1, further comprising a diffuser between said second LCD layer and said light source.

3. The device of claim 1 wherein said touch interface comprises:
a clear sheet including said display surface;
an infrared camera having a view of said clear sheet; and
infrared LEDs disposed to project infrared light on said clear sheet to be reflected toward said infrared camera upon user touch.

4. The device of claim 3 wherein said infrared LEDs are embedded around said clear sheet.

5. The device of claim 1 wherein said second LCD layer also generates monoscopic images.

6. The device of claim 5, wherein said second LCD layer generates monoscopic and stereoscopic images simultaneously.

7. The device of claim 1 wherein said first and second LCD layers comprise a plurality displays tiled together.

8. The device of claim 1 further comprising:
a video camera; and
a network controller configured for networking said device to at least one additional remote display device for remote collaboration.

9. A display system, comprising:
a display device in accordance with claim 1;
a computer-readable storage medium; and
software stored on said computer-readable storage medium for controlling said display device, said software system comprising a display application manager that manages two-dimensional content to be rendered monoscopically by said second LCD layer and manages three-dimensional content to be rendered stereoscopically by said second LCD layer.

10. The system of claim 9 wherein said application manager generates a three-dimensional scene description, said software further comprising a dynamic parallax barrier module to generate three dimensional image data from said three-dimensional scene description and overlay two-dimensional image data with the three-dimensional image data.

11. The system of claim 10 further comprising a finger tracker module to provide said display application manger with touch interface data.

12. The system of claim 11, wherein said finger tracker module communicates with said display application manager via a network connection.

13. An interactive display device comprising:
a display surface;
a gesture interface associated with said display surface;
a first LCD layer for generating a dynamic parallax barrier;
a second LCD layer for generating stereoscopic images in cooperation with said first LCD layer; and
a light source disposed to backlight said first and second LCD layers.

14. A method for controlling an interactive stereoscopic display device having a first LCD layer that generates a dynamic parallax barrier and a second LCD layer that can generate monoscopic and stereoscopic display, the method comprising the steps of:
providing two-dimensional content to be displayed by the second LCD layer;
providing three-dimensional content to be displayed by the second LCD layer;
generating a description that overlays two-dimensional content to be rendered monoscopically onto three-dimensional content to be rendered stereoscopically; and
providing parallax barrier content to be displayed on the first LCD layer.

15. The method of claim 14 further comprising the steps of:
tracking plural users; and
rendering a pair of images for each user based on the scene description, wherein one image is rendered for viewing by the user's left eye and the other image is rendered for viewing by the user's right eye.

16. The method of claim 15 further comprising the steps of:
electronically slicing s pair of images rendered in said step of rendering into a plurality of thin pieces;
combining the pieces from the pair of images into a single image; and
displaying the single image on the second LCD layer.

17. The method of claim 16 further comprising the step of:
sensing user interaction with the display device.

18. A method for displaying images on an interactive stereoscopic display device having a first LCD layer that generates a dynamic parallax barrier and a second LCD layer that can generate monoscopic and stereoscopic display, the method comprising the steps of:
overlaying monoscopic and stereoscopic image data into combined image data and displaying the combined image data to the second LCD layer;
displaying dynamic parallax barriers on the first LCD layer in cooperation with said second LCD layer;
sensing user interaction with the display device; and
adjusting the combined image data in response to user interaction.
